(19) United States
(12) Patent Application Publication
(10) Pub. No.: US 2021/0035467 A1
(43) Pub. Date: Feb. 4, 2021

(54) RECOMMENDATION ENGINE FOR GENERATING A RECOMMENDED ASSESSMENT AND A RECOMMENDED ACTIVITY FOR A USER

(71) Applicant: Pearson Education, Inc., Bloomington, MN (US)

(72) Inventors: Mark BOSKO, San Antonio, TX (US); Vishnu Vardhan VANAVADA, San Antonio, TX (US)

(21) Appl. No.: 16/526,865

(22) Filed: Jul. 30, 2019

(51) Int. Cl. G09B 19/00; G06F 11/34; G09B 5/00; G06N 3/08

(52) U.S. Cl. CPC G09B 19/00; G06F 11/3428; G06N 3/08; G09B 5/00; G06F 11/3438

(57) ABSTRACT

A system and method for recommending and performing a recommended assessment and a recommended activity for a user is provided. A first database stores a plurality of assessments with a common template and a plurality of possible activities with a common template. A second database stores, for each user in a plurality of users, a plurality of assessment results with self-identifying score types and a plurality of performed activities performed by the user. A recommendation engine may receive as input a plurality of assessments results and a plurality of performed activities performed by the user. The recommendation engine may output one or more recommended assessments and one or more recommended activities to be performed by the user. A user interface may display the recommended assessment(s) and the recommended activit(ies) to the user. An education platform may perform the recommended assessment(s) and the recommended activit(ies) with the user.

### FIELD OF THE INVENTION

This disclosure relates to the field of expert systems, specifically, educational expert systems that may be used to recommend assessments and possible activities for a user.

### SUMMARY OF THE INVENTION

The present invention provides systems and methods comprising one or more server hardware computing devices or client hardware computing devices, communicatively coupled to a network, and each comprising at least one processor executing specific computer-executable instructions within a memory that, when executed, cause the system to perform the present invention.

The present invention generates one or more recommended assessments and/or one or more recommended activities for a user. The recommended assessments and/or recommended activities form an action plan that the user can perform to assist the user in developing one or more academic skills (such as learning a new language).

The present invention may comprise a first database. The first database may be a database or a fileserver. The first database may store a plurality of assessments, such as tests and examinations. In preferred embodiments, the plurality of assessments includes at least one benchmark assessment, at least one progress monitoring assessment, and at least one formative assessment. In preferred embodiments, each assessment, in the plurality of assessments, is formatted to a common assessment template. This allows one or more new assessments to be added to the plurality of assessments already stored in the first database without having to change the software for the system.

The first database may also store a plurality of possible activities, such as assignments, projects and/or tasks. Each activity in the plurality of possible activities is designed to improve at least one skill. In preferred embodiments, each possible activity is formatted to a common activity template. This allows one or more new activities to be added to the plurality of activities already stored in the first database without having to change the software for the system.

The present invention may also comprise a second database (the first database and the second database may be the same or different databases, of the same or different types, located in the same or different places and operated using the same or different software and hardware.) The second database may be a database or fileserver. The second database may store, for each user in a plurality of users, assessment results for the user. The assessment results preferably comprise self-identifying test scores for various assessments taken by the user. The second database may also store a plurality of performed activities performed by the user.

The present invention may also comprise a recommendation engine of any desired type. As non-limiting examples, the recommendation engine may be a smart machine and/or have artificial intelligence. The recommendation engine may comprise a neural network trained to perform its function. In a preferred embodiment, the recommendation engine may receive one or more assessment results of a user and/or one or more performed activities already performed by the user. In some embodiments only the most recent assessment results for the user and/or the most recent activities performed by the user are sent to the recommendation engine. As a specific example, only the assessment results and the performed activities within the last year or the last six months are sent to the recommendation engine.

The recommendation engine may generate an output comprising a recommended assessment and a recommended activity. In preferred embodiments the recommended assessment is in the plurality of assessments and the recommended activity in the plurality of possible activities.

The present invention may also comprise a user interface. The user interface may be configured to display the recommended assessment and the recommended activity to the user on a display of a client device.

The present invention may also comprise an education platform. The education platform may be an on-line system that allows users to perform recommended assessments and the recommended activities by the users of the on-line system.

The above features and advantages of the present invention will be better understood from the following detailed description taken in conjunction with the accompanying drawings.

### BRIEF DESCRIPTION OF THE DRAWINGS

FIG. 1 illustrates a system level block diagram for a non-limiting example of a distributed computing environment that may be used in practicing the invention.

FIG. 2 illustrates a system level block diagram for an illustrative computer system that may be used in practicing the invention.

FIG. 3 illustrates a system level block diagram for generating a recommended assessment and a recommended activity for a user.

FIG. 4 illustrates a recommendation engine which may be used to generate the recommended assessment and the recommended activity for the user.

FIGS. 5-6 illustrates flowcharts for a method of generating and the recommended assessment and the recommended activity for the user.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Network

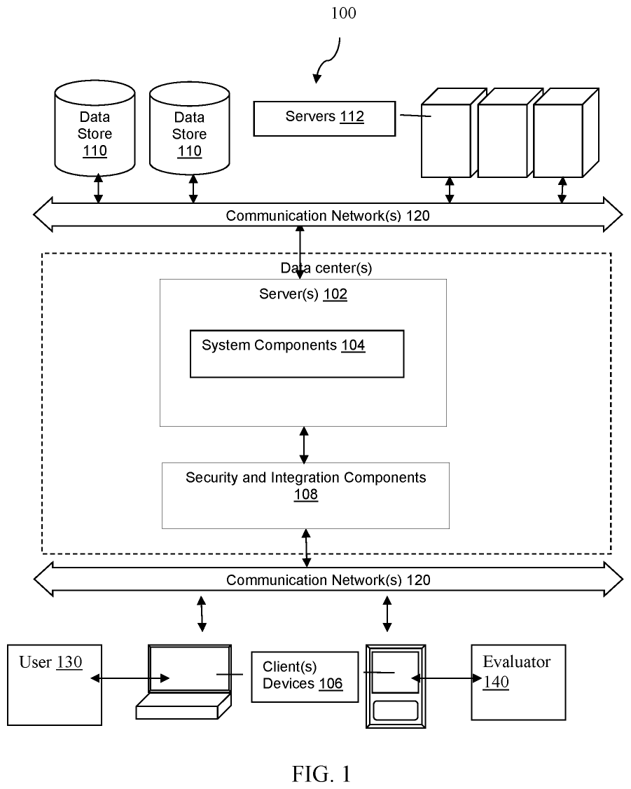

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

Servers/Clients

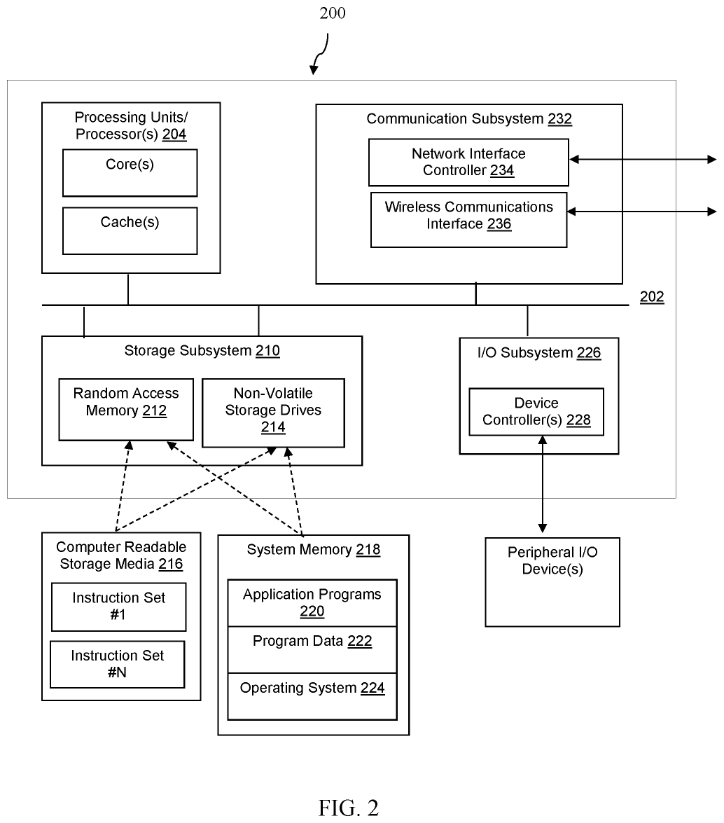

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Data Stores (Databases)

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

Input Output Streams Etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

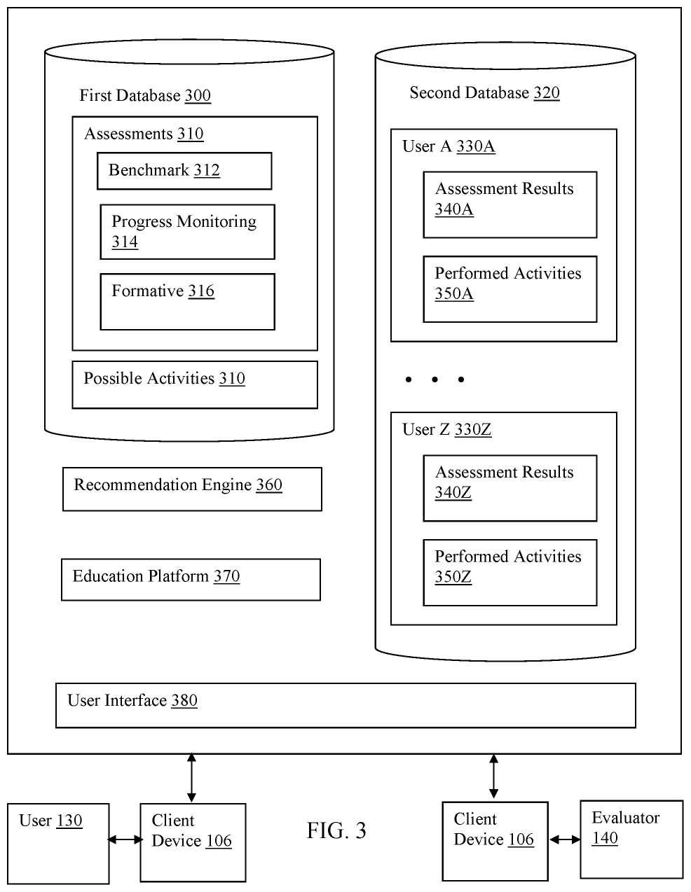

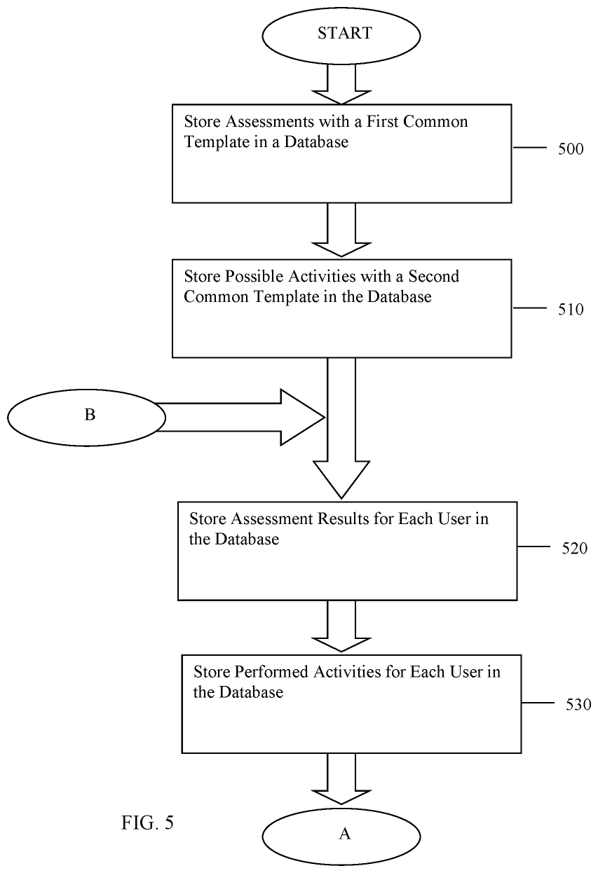

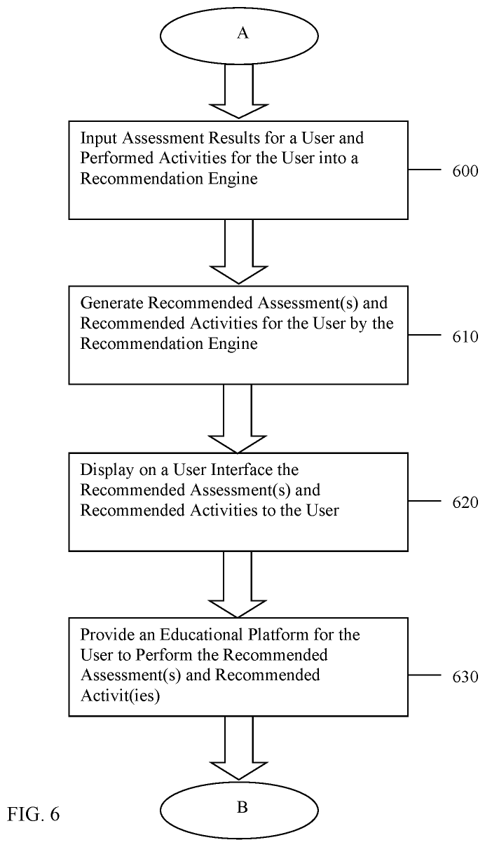

FIGS. 3, 5 and 6 illustrate systems and methods for generating one or more recommended assessments 400 and/or one or more recommended activities 410 for a user 130. The assessments 310 may be any type of desired assessments. As non-limiting examples, the assessments 310 may be of a diagnostic, formative and/or summative type. The assessments 310 may include a wide variety of methods and tools used to evaluate, measure and document the user's readiness, learning progress, skill acquisition and/or education needs of the user 130. In a preferred embodiment, the assessments 310 comprise benchmark assessments 312, Progress monitoring assessments 314 and formative assessments 316.

Benchmark assessments 312 are herein defined to set measurable standards for learning and rank the user 130 against a group of other students. The user 130 is similar in some manner (same grade or length of time learning a subject) to the other students in the group.

Progress monitoring assessments 314 are herein defined to be used to assess the user's academic performance, to quantify a user's rate of improvement or responsiveness to instruction and/or to evaluate the effectiveness of instruction.

Formative assessments 316 are herein defined to be a test that helps users 130 identify strengths and weaknesses and target areas that need work.

The user 130 is herein defined as the person that is attempting to improve an educational skill, such as improving their speaking, writing, comprehension and/or vocabulary in one or more languages. The invention contemplates many users using the invention (possibly taking the same or different assessments 310 and/or performing the same or different activities) at the same time. In this manner, each student may progress at the user's own desired rate or ability.

The invention includes a first database 300 storing a plurality of assessments 310 as described above. The first database 300 may be a database or fileserver. In a preferred embodiment, the assessments 310 stored by the first database 300 comprise benchmark assessments 312, Progress monitoring assessments 314 and formative assessments 316. Each assessment in the plurality of assessments 310 is formatted to follow a common assessment template. (Step 500) A common assessment template may be a structured file, such as XML, or a set of database fields that comprises the following information: (1) a description of the assessment and its (resulting) score, the encoding rules for the assessment results 340, subtests and items (as non-limiting examples, “MC” may mean Math Calculation, “NPR” may mean National Percentage Rank, “WPM” may mean words per minute, “WPMS” may mean words per minute scale score and “WPMPL” may mean words per minute performance label); (2) the information needed to present the assessment to a user interface; and (3) the encoded scores using the coding in the description.

In preferred embodiments, the plurality of assessments 310 are configured so that a new assessment, that is formatted to the common assessment template, may be added to the plurality of assessments 310 without requiring a change to any software of the system.

The first database 300 may also store a plurality of possible activities 310. Activities are herein defined to be activities that the user 130 may perform that impart knowledge and/or skill to any potential performer of the activity other than an assessment 310. As non-limiting examples, the activities may be reading, writing or speaking assignments, performing various projects, tasks or assignments, interacting with other students and/or any combination of these activities. A common activity template may also be followed by all of the activities in the plurality of activities stored in the first database 300. (Step 510)

In preferred embodiments, the plurality of possible activities 310 are configured so that a new activity, that is formatted to the common activities template, may be added to the plurality of possible activities 310 without requiring a change to any software of the system.

The invention may also include a second database 320. It should be appreciated that the first database 300 and the second database 320 may be the same or different databases, of the same or different types of databases and/or physically operated on the same or different hardware servers. The second database 320 may be a database or a fileserver. In preferred embodiments, the second database 320 may store data that is specific to each user 130 in a plurality of users. Specifically, the second database 320 may store, for each user 130, assessment results 340 for the user 130 and the activities already performed by the user 130. (Step 520)

The assessment results 340 may be generated by the user 130 taking one of the assessments 310. The assessment results 340 stored in the first database 300. The assessment results 340 are also preferably of a self-identifying score type. As a specific example, an assessment result may be “25 out of 31” or “25/31” which might be used to indicate the user 130 scored a 25 on a test that allowed students to score up to a 31.

The second database 320 may also store a plurality of performed activities performed by the user 130. (Step 530) Each performed activity, in the plurality of performed activities, is preferably one of the activities in the plurality of possible activities 310 that may be performed by the user 130. Referring to FIG. 3, the second database 320 may store for a User A 330A Assessment Results 340A and Performed Activities 350A and for a User Z 330Z Assessment Results 340Z and Performed Activities 350Z. Thus, the second database may store, for a plurality of different users, corresponding assessment results 340 and performed activities for each user 130 in the plurality of users.

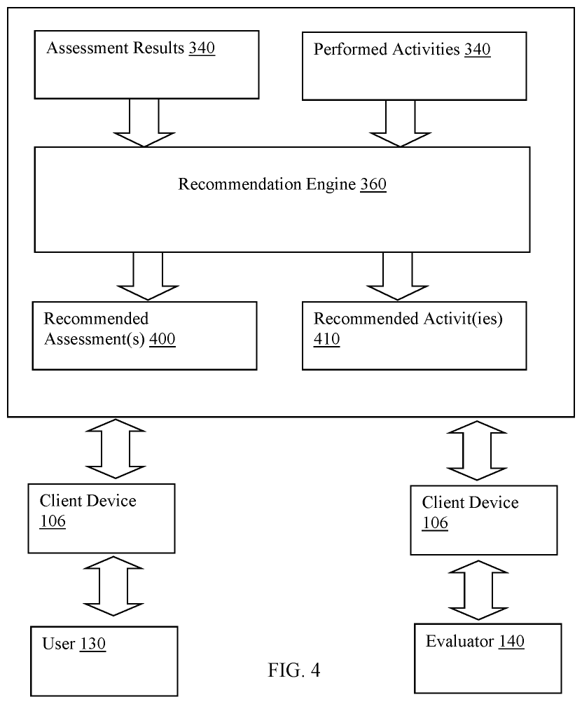

Referring to FIG. 4, the invention may also comprise a recommendation engine 360. The recommendation engine 360 may comprise software and hardware. In some embodiments, the recommendation engine 360 may have artificial intelligence and be comprised of a neural network. In preferred embodiments the recommendation engine 360 is able to be trained (learns) using past assessment results 340 and past performed activities of other past test subjects in order to recommend assessments and/or recommend activities to users 130.

The recommendation engine 360, once programmed or trained to a desired level, may receive from the second database 320 one or more assessment results 340 for the user 130 and/or one or more performed activities performed by the user 130. (Step 600) In some embodiments only the most recent assessment results 340 for the user 130 and/or the most recent activities performed by the user 130 are sent to the recommendation engine 360. The recommendation engine 360 may use the assessment results 340 for the user 130 and the activities performed by the user 130 to generate one or more recommended assessments 400 to be taken by the test subject and/or one or more recommended activities 410 to be performed by the test subject. (Step 610) The recommended assessments 400 and recommended activities 410 are preferably in the plurality of assessments 310 and the plurality of possible activities 310 stored in the first database 300.

In a possible embodiment, the recommendation engine 360 may generate an output using the equation O(n, t)=R(key, I). The vector O(n, t) may comprise an output information vector used to determine the recommended assessment 400 and/or the recommended activity 410 for the user 130. This vector may have any desired number of dimensions. The key may be based, at least in part, on a time of year, a grade, an age of the user 130 and/or one or more of the performed activities of the user 130. The I may be a score or number (such as an average score or ranking of the user 130) based, at least in part, on the plurality of assessment results 340 for the user 130.

In some embodiments, the invention may comprise a plurality of recommended assessments 400 and a plurality of recommended activities 410 from which the recommendation engine 360 may use in determining the recommended assessment 400 and/or the recommended activity for the user 130. The plurality of recommended assessments 400 and the plurality of recommended activities 410 may be stored in the first database 300 or a file server. In preferred embodiments, the plurality of recommended assessments 400 use a common recommended assessment template and the plurality of recommended activities 410 use a common recommended activities template. This allows a new recommended assessment to be added to the plurality of recommended assessments without requiring a change to the software of the system and allows a new recommended activity to be added to the plurality of recommended activities without requiring a change to the software of the system.

The present invention may also comprise a user interface 380. The user interface 380 may be any desired type of user interface 380. As non-limiting examples, the user interface 380 may be a website that communicates to a browser on a client device 106 or an Application Programming Interface (API) that communicates with an application running on the client device 106. The user interface 380 may transmit one or more recommended assessments 400 and/or one or more recommended activities 410 to either a client device 106 of a user 130 and/or a client device 106 of the evaluator 140. (Step 620) In this manner either the user 130 or the evaluator 140 will then know which assessment(s) and which possible activit(ies) the user 130 should do next.

Once the user 130 or evaluator 140 knows what assessments 310 and/or activities are to be performed by the user 130, the user 130 or evaluator 140 may use an education platform 370 to allow the user 130 to perform the recommended assessment 400 and the recommended activity 410. (Step 630) As a non-limiting example, the education platform 370 may be an on-line service that may be used to administer the recommended assessments 400 or provide guidance and the necessary materials to the user 130 to perform the recommended activities 410.

In some embodiments, the user 130 might be an individual user and is not part of a class or subgroup of other users of the present invention. The present invention allows the individual user 130 to progress at the desired speed or rate of the user 130. This prevents the user 130 from being part of a group that is moving either too fast for the user 130 or too slow for the user 130. Thus, the present invention may be used by any number of individual users that are all moving at their own desired rate of progress. The present invention may also be used by groups of users, but the present invention allows each individual in a group to receive a custom action plan (recommended assessments 400 and/or recommended activities 410) based on the assessment results 340 and performed activities of the user 130.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system for generating a recommended assessment and a recommended activity by a user, comprising:
a first database storing:
a plurality of assessments,
wherein the plurality of assessments comprises:
at least one benchmark assessment,
at least one progress monitoring assessment, and
at least one formative assessment, and
wherein each assessment, in the plurality of assessments, is formatted to a common assessment template,
a plurality of possible activities,
wherein each activity in the plurality of possible activities is:
designed to improve at least one skill and
formatted to a common activity template;
a second database storing, for each user in a plurality of users,:
a plurality of assessment results, wherein each assessment result, in the plurality of assessment results:
is generated from the user taking one of the assessments in the plurality of assessments, and
is a self-identifying score type, and
a plurality of performed activities performed by the user, wherein each performed activity, in the plurality of performed activities, is in the plurality of possible activities;
a recommendation engine configured to:
receive from the second database as input:
the plurality of assessments results, and
the plurality of performed activities performed by the user; and
generate an output comprising:
the recommended assessment, wherein the recommended assessment is in the plurality of assessments and
the recommended activity, wherein the recommended activity is in the plurality of possible activities;
a user interface, configured to display the recommended assessment and the recommended activity to the user; and
an education platform configured to allow the user to perform the recommended assessment and the recommended activity using the education platform.

2. The system of claim 1, wherein the plurality of assessments are configured so that a new assessment, that is formatted to the common assessment template, is added to the plurality of assessments without requiring a change to any software of the system.

3. The system of claim 1, wherein the plurality of possible activities are configured so that a new activity, that is formatted to the common activities template, is added to the plurality of possible activities without requiring a change to any software of the system.

4. The system of claim 1, wherein the first database and the second database are the same database.

5. The system of claim 1, wherein the recommendation engine generates the output using the equation O(n, t)=R(key, I), wherein:
O(n, t) comprises an output information vector used to determine the recommended assessment and/or the recommended activity,
the key is based at least in part on a time of year, a grade, an age of the user and/or the plurality of performed activities, and
the I is based on the plurality of assessment results.

6. The system of claim 1, wherein the recommendation engine comprises a neural network that is trained on a plurality of past recommended activities and a plurality of past assessment results from a plurality of past users

7. The system of claim 1, wherein the user is associated with the plurality of assessment results of the user and the plurality of performed activities performed by the user, but the user is not associated with a subgroup of users within a plurality of users using the education platform.

8. A method for generating a recommended assessment and a recommended activity by a user, comprising the steps of:
storing, by a first database,
a plurality of assessments,
wherein the plurality of assessments comprises:
at least one benchmark assessment,
at least one progress monitoring assessment, and
at least one formative assessment, and
wherein each assessment, in the plurality of assessments, is formatted to a common assessment template,
a plurality of possible activities, wherein each activity in the plurality of possible activities is designed to improve at least one skill and is formatted to a common activity template,
storing, by a second database, for each user in a plurality of users,
a plurality of assessment results, wherein at least one assessment result is a benchmark assessment, at least one assessment result is a programs monitoring assessment and at least one assessment result is a formative assessment,
wherein each assessment result, in the plurality of assessment results:
is generated from the user taking one of the assessments in the plurality of assessments and
is a self-identifying score type, and
a plurality of performed activities performed by the user, wherein each performed activity, in the plurality of performed activities, is in the plurality of possible activities;
receiving by a recommendation engine as input from the second database:
the plurality of assessments results, and
the plurality of performed activities performed by the user;
generating by the recommendation engine an output, wherein the output comprises:
the recommended assessment, wherein the recommended assessment is in a plurality of recommended assessments and
the recommended activity, wherein the recommended activity is in a plurality of recommended activities;
displaying, by a user interface, the recommended assessment and the recommended activity to the user; and
performing by an education platform, the recommended assessment and the recommended activity with the user on the education platform.

9. The method of claim 8, wherein the plurality of assessments are configured so that a new assessment, that is formatted to the common assessment template, is added to the plurality of assessments without requiring a change to any software of the system and the plurality of activities are configured so that a new activity, that is formatted to the common activities template, is added to the plurality of activities without requiring a change to any software of the system.

10. The method of claim 9, wherein the plurality of recommended assessments is configured so that a new recommended assessment , that is formatted to a common recommended assessment template, is added to the plurality of recommended assessments without requiring a change to any software of the system and the plurality of recommended activities is configured so that a new recommended activity, that is formatted to a common recommended activities template, is added to the plurality of recommended activities without requiring a change to any software of the system.

11. The method of claim 8, wherein the first database and the second database are the same database.

12. The method of claim 8, wherein the output is generated by the recommendation engine using the equation O(n, t)=R(key, I), wherein:
O(n, t) comprises an output information vector used to determine the recommended assessment and/or the recommended activity,
the key is based at least in part on a time of year, a grade, an age of the user and/or the plurality of performed activities, and
the I is based on the plurality of assessment results.

13. The method of claim 8, wherein the recommendation engine comprises a neural network that is trained on a plurality of past recommended activities and a plurality of past assessment results from a plurality of past users

14. The method of claim 8, wherein the user is associated with the plurality of assessment results of the user and the plurality of performed activities performed by the user, but the user is not associated with a subgroup of users within a plurality of users using the education platform.

15. A method for generating a recommended assessment and a recommended activity by a user, comprising the steps of:
storing, by a first database,
a plurality of assessments,
wherein each assessment, in the plurality of assessments, is formatted to a common assessment template,
a plurality of possible activities, wherein each activity in the plurality of possible activities is designed to improve at least one skill and is formatted to a common activity template,
storing, by a second database, for each user in a plurality of users,
a plurality of assessment results, wherein at least one assessment result is a benchmark assessment, at least one assessment result is a programs monitoring assessment and at least one assessment result is a formative assessment,
wherein each assessment result, in the plurality of assessment results:
is generated from the user taking one of the assessments in the plurality of assessments and
is a self-identifying score type, and
a plurality of performed activities performed by the user, wherein each performed activity, in the plurality of performed activities, is in the plurality of possible activities;
receiving by a recommendation engine as input from the second database:
the plurality of assessments results, and
the plurality of performed activities performed by the user;
generating by the recommendation engine an output, wherein the output comprises:
the recommended assessment, wherein the recommended assessment is in the plurality of assessments,
the recommended activity, wherein the recommended activity is in the plurality of possible activities,
wherein the output is generated by the recommendation engine using the equation O(n, t)=R(key, I), wherein:
O(n, t) comprises an output information vector used to determine the recommended assessment and/or the recommended activity,
the key is based at least in part on the plurality of performed activities, and
the I is based on the plurality of assessment results;
displaying, by a user interface, the recommended assessment and the recommended activity to the user; and
performing by an education platform, the recommended assessment and the recommended activity with the user on the education platform.

16. The method of claim 15, wherein the plurality of assessments are configured so that a new assessment, that is formatted to the common assessment template, is added to the plurality of assessments without requiring a change to any software of the system.

17. The method of claim 15, wherein the plurality of possible activities are configured so that a new activity, that is formatted to the common activities template, is added to the plurality of possible activities without requiring a change to any software of the system.

18. The method of claim 15, wherein the first database and the second database are the same database.

19. The method of claim 15, wherein the recommendation engine comprises a neural network that is trained on a plurality of past recommended activities and a plurality of past assessment results from a plurality of past users

20. The method of claim 15, wherein the user is associated with the plurality of assessment results of the user and the plurality of performed activities performed by the user, but the user is not associated with a subgroup of users within a plurality of users using the education platform.
